(19) United States
(12) Patent Application Publication
(10) Pub. No.: US 2014/0126005 A1
(43) Pub. Date: May 8, 2014

(54) METHOD FOR CONTROLLING IMAGE PROCESSING DEVICE

(71) Applicant: Seiko Epson Corporation, Tokyo (JP)

(72) Inventor: Teiko HANAWA, Shiojiri (JP)

(73) Assignee: Seiko Epson Corporation, Tokyo (JP)

(21) Appl. No.: 14/068,215

(22) Filed: Oct. 31, 2013

(30) Foreign Application Priority Data
Nov. 8, 2012 (JP) 2012-246045

(51) Int. Cl. H04N 1/60

(52) U.S. Cl. CPC H04N 1/6027
USPC 358/1.9

(57) ABSTRACT

A multifunction printer, which generates first image data of a document by reading the document, generates second image data in which a background color of the document is removed by conducting a color conversion process to the first image data, and prints an image based on the second image data, has a background color density computing section which computes background color density of the document from the first image data, a color conversion table generating section which generates a first color conversion table and a second color conversion table based on the background color density, and an image processing section which separates an image shown by the first image data into a letter region and a non-letter region, converts the color by applying the first color conversion table to the letter region, and converts the color by applying the second color conversion table to the non-letter region.

### CROSS-REFERENCE TO RELATED APPLICATIONS

This application claims priority to Japanese Patent Application No. 2012-246045 filed on Nov. 8, 2012. The entire disclosure of Japanese Patent Application No. 2012-246045 is hereby incorporated herein by reference.

### BACKGROUND

1. Technical Field

The present invention relates to an image processing device and a method for processing an image processing device.

2. Background Technology

A multifunction printer which achieves a scanner function, a printer function, a copy function in one is in widespread use. As shown in Patent Document 1, in such a multifunction printer, a background color removal processing function has been known, which generates a copy image in which a faint color of a document is converted into a white color and a background color of the document or a color of offset is removed by computing the background color density of the document and conducting a color conversion process in a printing device using a color conversion table based on the background color density.

Japanese Laid-open Patent Publication No. H1-213073 (Patent Document 1) is an example of the related art.

### SUMMARY

### Problems To Be Solved By the Invention

However, in a case where the document includes white letters on a colored background of higher density than the background color or the background, the visibility of the white letters will be deteriorated by making the background color or the background white in the background color removal process, which will make the white letters illegible sometimes. The invention has been made in terms of the above-described circumstances, and an advantage of the invention is to prevent the visibility from being deteriorated in a case of conducting a background color removal process to a document which includes letters of higher density than the background color or the background.

### Means Used To Solve the Above-Mentioned Problems

In order to address at least part of the above-described circumstances, the invention can be implemented as the following embodiments and application examples.

### APPLICATION EXAMPLE 1

According to this application example, an image processing device, which generates first image data of a document by reading the document, generates second image data in which a background color of the document is removed by conducting a color conversion process to the first image data, and prints an image based on the second image data, has a background color density computing section which computes background color density of the document from the first image data, a color conversion table generating section which generates a first color conversion table and a second color conversion table based on the background color density, and an image processing section which separates an image shown by the first image data into a letter region and a non-letter region, converts the color by applying the first color conversion table to the letter region, and converts the color by applying the second color conversion table to the non-letter region.

With this configuration, the first image data of the document is separated into a letter region and a non-letter region, and the two color conversion tables generated based on the background color density of the document are applied to the letter region and the non-letter region, respectively. Therefore, the colors of the letter region and the non-letter region are converted based on the different color conversion tables, respectively. It is thus possible to avoid a situation in which the density of the letter region and the non-letter region becomes close and the visibility of the letter region is deteriorated by appropriately generating the color conversion tables for conducting different color conversion to the letter region and the non-letter region in a case of removing the background of the document.

### APPLICATION EXAMPLE 2

In the image processing device according to the above-described application example, preferably, the brightness of the letter region is decreased by applying the first color conversion table to color conversion.

With this configuration, the brightness of the letter region is decreased by applying the first color conversion table to the letter region, which makes it easy to distinguish from the non-letter region whose color is converted by the second color conversion table.

### APPLICATION EXAMPLE 3

In the image processing device according to the above-described application example, preferably, the first color conversion table converts the color of the letter region such that a brightness difference between the letter region and the background of the document is substantially identical before and after removing the background color.

With this configuration, since the brightness difference between the letter region and the background of the document is substantially identical before and after removing the background color, the visibility of the letter region can be maintained after removing the background color.

### APPLICATION EXAMPLE 4

In the image processing device according to the above-described application example, the tone of the letter region can be decreased by applying the first color conversion table to color conversion.

### APPLICATION EXAMPLE 5

In the image processing device according to the above-described application example, the background color density computing section computes the background color density by statistically processing a density distribution of the first image data.

With this configuration, the background color density can be computed with good accuracy by statistically processing the density distribution of the first image data.

### APPLICATION EXAMPLE 6

In the image processing device according to above-described application example, the image processing section can have a letter region judging section which separates an image shown by the first image data into a letter region and a non-letter region, a color conversion table determining section which determines the first color conversion table to be applied to the letter region and determines the second color conversion table to be applied to the non-letter region, and a color converting section which removes the background color in the image by applying the first color conversion table to the letter region so as to convert the color of the letter region and applying the second color conversion table to the non-letter region so as to convert the color of the non-letter region.

### APPLICATION EXAMPLE 7

According to this application example, a method for controlling an image processing device, which generates first image data of a document by reading the document, generates second image data in which a background color of the document is removed by conducting a color conversion process to the first image data, and prints an image based on the second image data, has a computing step which computes the background color density of the document from the first image data, a generating step which generates a first color conversion table and a second color conversion table based on the background color density, and a color converting step which separates an image shown by the first image data into a letter region and a non-letter region, converts the color by applying the first color conversion table to the letter region, and converts the color by applying the second color conversion table to the non-letter region.

With this method, the first image data of the document is separated into a letter region and a non-letter region, and the two color conversion tables generated based on the background color density of the document are applied to the letter region and the non-letter region, respectively. Therefore, the colors of the letter region and the non-letter region are converted based on the different color conversion tables, respectively. It is thus possible to avoid a situation in which the density of the letter region and the non-letter region becomes close and the visibility of the letter region is deteriorated by appropriately generating the color conversion tables for conducting different color conversion to the letter region and the non-letter region in a case of removing the background of the document.

### APPLICATION EXAMPLE 8

According to this application example, an image processing device, which generates first image data of a document by reading the document, generates second image data in which a background color of the document is removed by conducting a color conversion process to the first image data, and prints an image based on the second image data, has a background color density computing section which computes the background color density of the document from the first image data, a color conversion table generating section which generates a first color conversion table and a second color conversion table based on the background color density, and an image processing section which separates an image shown by the first image data into an edge region and a non-edge region, converts the color by applying the first color conversion table to the edge region, and converts the color by applying the second color conversion table to the non-edge region.

With this configuration, the first image data of the document is separated into an edge region and a non-edge region, and the two color conversion tables generated based on the background color density of the document are applied to the edge region and the non-edge region, respectively. Therefore, the colors of the edge region and the non-edge region are converted based on the different color conversion tables, respectively. It is thus possible to avoid a situation in which the density of an image which forms the edge and the background becomes close and the visibility is deteriorated by appropriately generating the color conversion tables for conducting different color conversion to the edge region and the non-edge region in a case of removing the background of the document.

### BRIEF DESCRIPTION OF THE DRAWINGS

Referring now to the attached drawings which form a part of this original disclosure:

FIG. 1 is a block diagram which shows a function configuration of a multifunction printer according to a first embodiment of the invention;

FIG. 2 is a diagram which shows the frequency distribution of the color density in first image data;

FIG. 3A shows the characteristics of a background removal table and FIG. 3B shows the characteristics of a brightness shift table; and

FIG. 4 is a block diagram which shows a function configuration of a multifunction printer according to a second embodiment of the invention.

### DETAILED DESCRIPTION OF EXEMPLARY EMBODIMENTS

Hereinafter, embodiments of the invention will be explained with reference to the drawings.

### First Embodiment

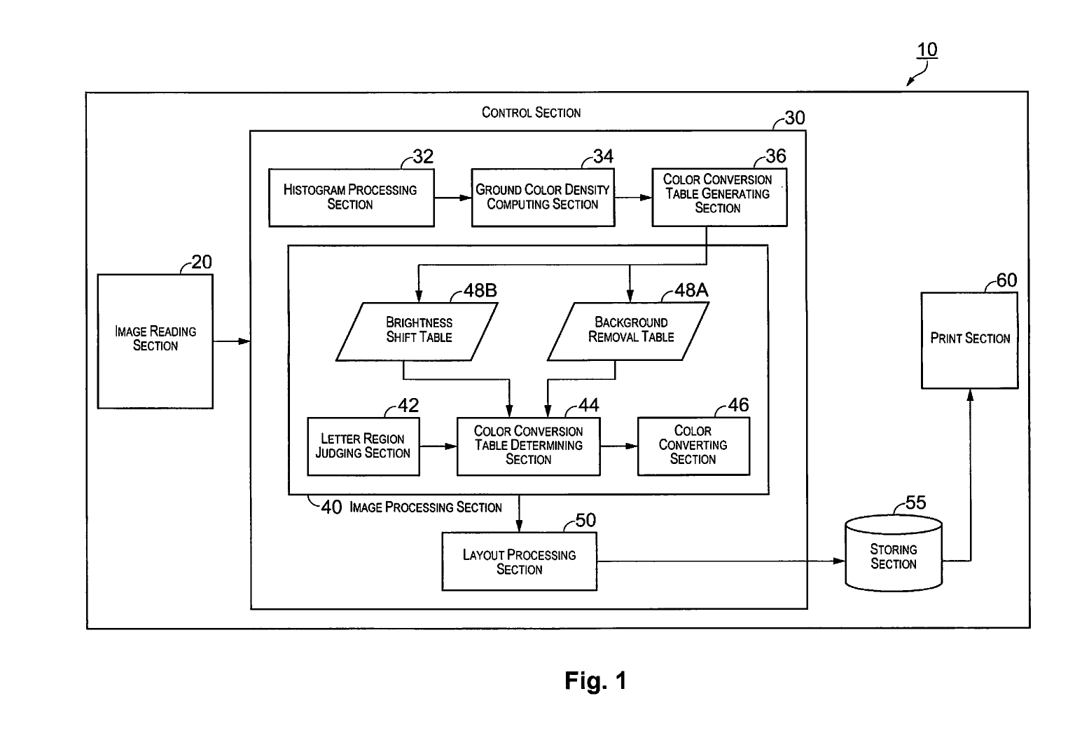

FIG. 1 is a block diagram which shows a function configuration of a multifunction printer 10 as an image processing device. The multifunction printer 10 has an image reading section 20, a control section 30, a storing section 55, and a print section 60. The control section 30 has a histogram processing section 32, a background color density computing section 34, a color conversion table generating section 36, an image processing section 40 and a layout processing section 50. The image processing section 40 has a letter region judging section 42, a color conversion table determining section 44, and a color converting section 46. The multifunction printer 10 has a copy function in which the image reading section 20 optically reads a document, the control section 30 conducts a predetermined process to an image of the document which has been read, and the print section 60 prints and outputs the image, to which the predetermined process has been conducted, onto a medium. Here, the predetermined process includes a background removal process which removes the background color of a document. A user can instruct the multifunction printer 10 to or not to conduct the background color removal through a predetermined user interface (not shown in the drawing).

In the first embodiment, an image scanner device is assumed as the image reading section 20. A computer device (not shown in the drawing), which has an external storing device such as a hard disc drive and is driven by predetermined OS, is assumed as the control section 30 and the storing section 55. An electrophotographic type printing device such as a color laser printer is assumed as the print section 60. The image reading section 20, the storing section 55, and the print section 60 are connected with the control section 30, respectively, so as to be able to communicate in accordance with predetermined communication standards in a wired or wireless manner. However, these sections are not limited to the embodiment described above. For example, the print section 60 can be an inkjet type printer. Also, the image reading section 20, the control section 30, the storing section 55, and the print section 60 can be integrally configured as the multifunction printer 10.

The control section 30 achieves sections described below by causing hardware of the computer device (for example, CPU, RAM, ROM, or the like) and software stored in the ROM, the storing section 55, or the like to cooperate with each other. The histogram processing section 32 acquires RGB (Red, Green, and Blue) data (first image data) of an image of a document which has been read by the image reading section 20, and generates a histogram which shows a frequency distribution of the RGB color density in the first image data. The background color density computing section 34 has a function of computing the background color density which is used as a reference value for removing the background color with respect to an image of a document by statistically processing the density distribution of the histogram generated by the histogram processing section 32. The computing step achieves this function.

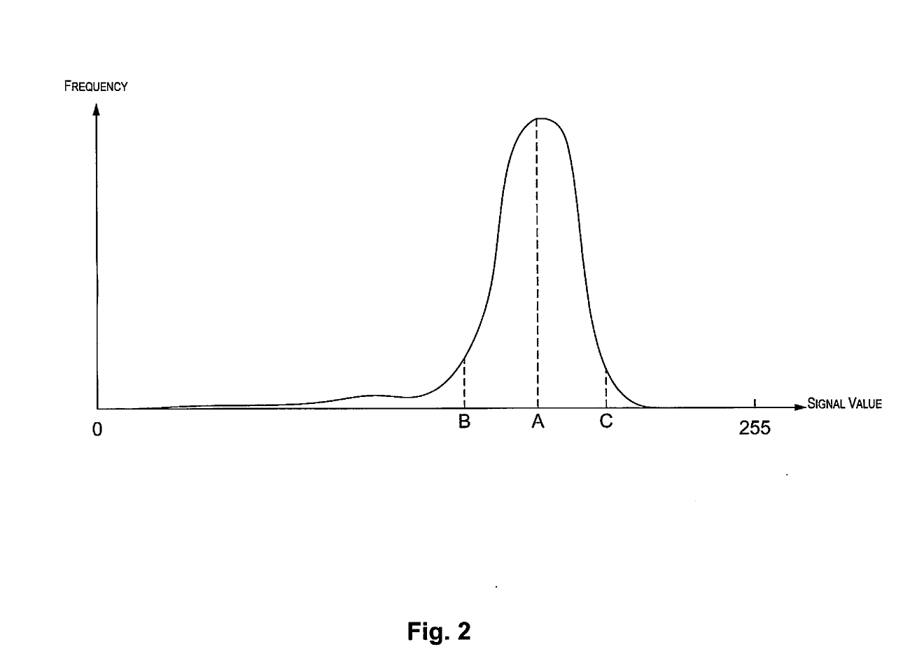

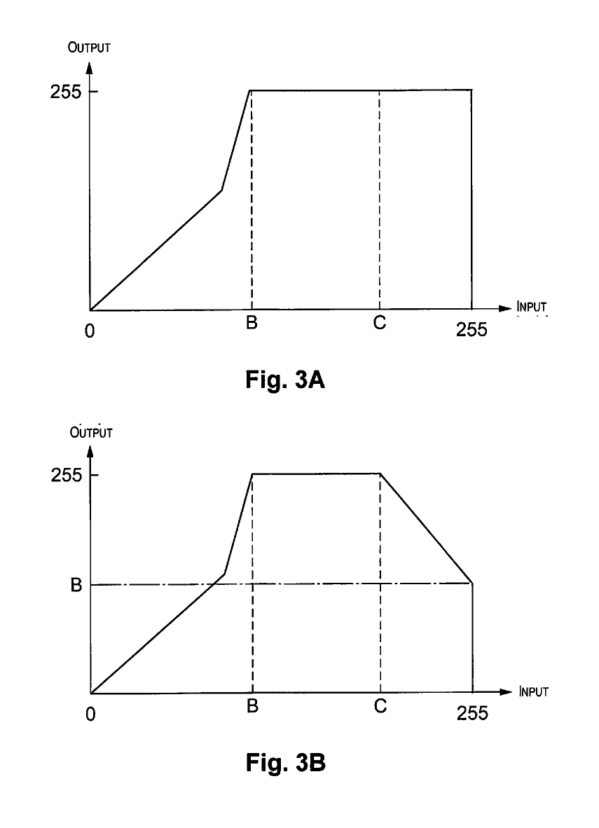

Here, the background color density will be explained with reference to FIG. 2. FIG. 2 shows an example of the histogram generated by the histogram processing section 32, and shows the frequency distribution of the RGB color density in the first image data. This histogram shows a frequency of high density of the base in a document whose color is close to white. The background color density computing section 34 considers the range from peak A to density B and density C in a predetermined range as the background color density. Here, the background color density can be set for each color of RGB, or can be set to be one value as a brightness value. Turning back to FIG. 1, the color conversion table generating section 36 has a function of generating a color conversion table for conducting the background color removal based on the background color density computed by the background color density computing section 34. The generating step achieves this function. The color conversion table is used for converting the color of image data constructed of RGB data. In the first embodiment, the color conversion table generating section 36 generates a background removal table (the second color conversion table) 48A whose characteristics are shown in FIG. 3A and a brightness shift table (the first color conversion table) 48B whose characteristics are shown in FIG. 3B. The two generated tables are retained in a storing region which can be referred from the image processing section 40.

The image processing section 40 acquires first image data of a document read by the image reading section 20, and conducts image processing, such as an image correction process, an edge process, a color conversion process, or the like, to the first image data. The letter region judging section 42 judges whether a pixel region is a letter region or a non-letter region in the first image data. The color conversion table determining section 44 determines a color conversion table to be applied based on the judgment results of the letter region judging section 42. Specifically, the color conversion table determining section 44 determines that the brightness shift table 48B is to be applied with respect to the letter region, and determines that the background removal table 48A is to be applied with respect to the non-letter region. Here, the following configuration is assumed as the first embodiment. The image processing section 40 does not conduct the color conversion process for each pixel of the document. The letter region judging section 42 separates the region into the letter region and the non-letter region based on the judgment results, and generates first image data of the letter region and first image data of the non-letter region. The color conversion table determining section 44 determines a color conversion table to be applied to each first image data.

The color converting section 46 has a function of generating second image data constructed of RGB data by referring to the two tables determined by the color conversion table determining section 44 and synthesizing the first image data after converting the colors of the first image data, respectively. The color converting step achieves this function. The second image data generated by the color converting section 46 is sent to the layout processing section 50. The layout processing section 50 generates third image data obtained by conducting a layout process such as rotation or the like to the image of the second image data sent from the image processing section 40. The generated third image data is stored in the storing section 55.

Here, explanations will be made on the background removal table 48A whose characteristics are shown in FIG. 3A and the brightness shift table 48B whose characteristics are shown in FIG. 3B. The background removal table 48A is generated such that output is conducted with density which has a linear relationship with the input density in a case where density less than density B is input, whitishness is strengthened as the input density becomes close to density B, and the density of a white color is output in a case where density equal to or more than density B is input. As a result of this, the base except for the letter region of the document, and a portion in which the density is lower (lighter) than the base are output as white. The brightness shift table 48B is generated such that output is conducted with density which has a linear relationship with the input density in a case where density less than density B is input, whitishness is strengthened as the input density becomes close to density B, and the density of a white color is output in a case where density in the range of density B to density C is input.

Further, the brightness shift table 48B is generated such that density which decreases the brightness is output as the input density becomes higher in a case where density more than density C is input. Specifically, as shown in FIG. 3B, a white color (255) is output in density C, the density decreases as the input density exceeds density C, and density B which is the input value for starting output of the density of a white color becomes the output value in a case where the input density is a white color (255). As a result of this, a portion in which the letter region of the document is drawn in a color of high brightness is output with decreased brightness. For example, faint yellow letters are output with being converted into dark yellow, and white letters on a colored background are output with being converted into gray. As a result of this, the brightness difference between the letters and the background is kept substantially identical before and after removing the background, and thus the visibility of the letters can be prevented from being deteriorated.

Here, the brightness shift table 48B can be configured such that it can be set through a predetermined user interface (not shown in the drawing). As a result of this, the brightness can be decreased by changing the letter region into another color. Also, the brightness shift table 48B can be generated such that density which decreases the tone is output as the input density becomes higher in a case where density more than density C is input. The print section 60 acquires the third image data stored in the storing section 55, converts the color of the acquired third image data based on a predetermined color conversion table (for example, a three-dimensional look-up table), and generates fourth image data constructed of CMYK (Cyan, Magenta, Yellow, and Black) data. An image based on the generated fourth image data is formed on a medium such as paper by a print engine (not shown in the drawing) of the print section 60.

According to the first embodiment described above, when copying a document, a background color of the document or a color of offset is removed, and the brightness of letters is decreased. Therefore, even in a case where the letters have high brightness such as white letters on a colored background, the visibility can be prevented from being deteriorated, and a copy image in which the letters of the document are easy to read can be generated.

### Second Embodiment

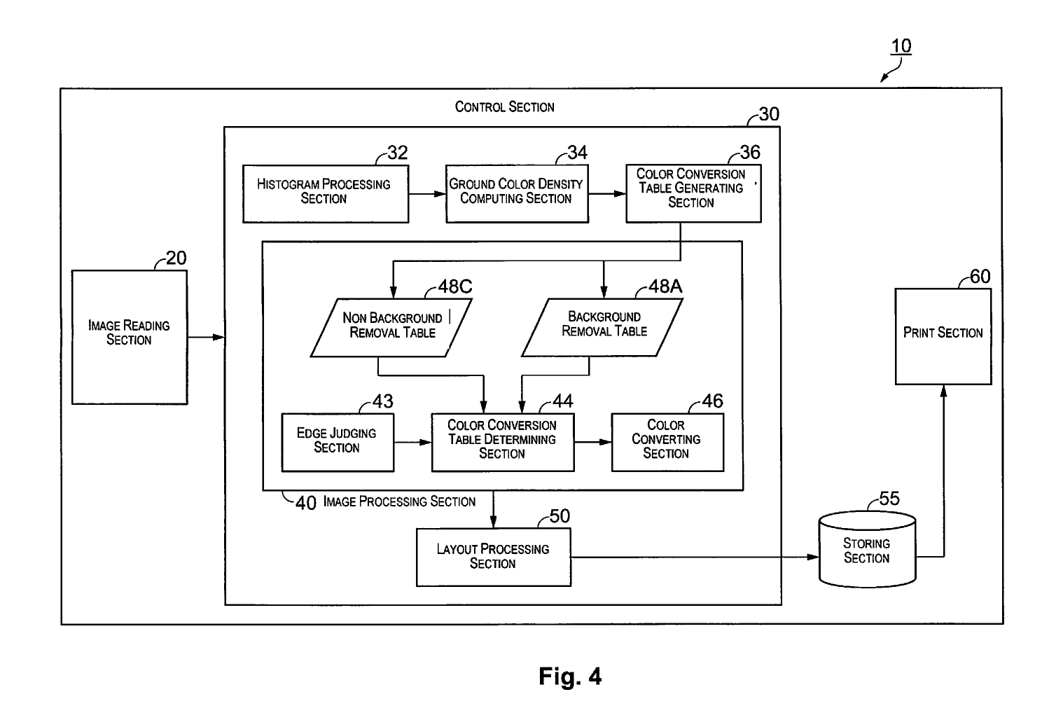

Next, the second embodiment of the invention will be explained with reference to FIG. 4. FIG. 4 is a block diagram which shows a function configuration of the multifunction printer 10 according to the second embodiment. In the following explanations, the same reference symbols are given to the same elements as the elements which have already been described, and explanations thereof will be omitted. In the first embodiment, the letter region judging section 42 judges whether the region is the letter region or the non-letter region, and the color is converted by applying the background removal table 48A to the non-letter region and applying the brightness shift table 48B to the letter region. In the second embodiment, however, the background removal table 48A is applied in a case where the target pixel is not in the edge and a non background removal table 48C is applied in a case where the target pixel is in the edge. The non background removal table 48C is generated by the color conversion table generating section 36. The non background removal table 48C is a color conversion table for a case in which the background removal process is not conducted, and the edge region does not undergo the background removal process in a case of converting the color by applying the non background removal table 48C. Therefore, in a case of white letters on a colored background having higher density than the background color or the background, since the background removal process is not conducted to the edge region, it is possible to avoid a situation in which the white letters on a colored background are made the same color as the background color or the background and the visibility will be deteriorated.

The device for implementing the above-described technique is achieved by a single device in some cases or is achieved by combining a plurality of devices in some cases, and includes various embodiments. Each configuration of each embodiment and the combination thereof are examples, and changes such as addition, omission or replacement of the configuration can be made without departing from the subject matter of the invention. The invention is not limited to the embodiments, and is limited only to the scope of claims.

What is claimed is:

1. An image processing device, which generates first image data of a document by reading the document, generates second image data in which a background color of the document is removed by conducting a color conversion process to the first image data, and prints an image based on the second image data, comprising:
a background color density computing section which computes background color density of the document from the first image data;
a color conversion table generating section which generates a first color conversion table and a second color conversion table based on the background color density; and
an image processing section which separates an image shown by the first image data into a letter region and a non-letter region, converts the color by applying the first color conversion table to the letter region, and converts the color by applying the second color conversion table to the non-letter region.

2. The image processing device according to claim 1, wherein brightness of the letter region is decreased by applying the first color conversion table to color conversion.

3. The image processing device according to claim 1, wherein the first color conversion table converts the color of the letter region such that a brightness difference between the letter region and the background of the document is substantially identical before and after removing the background color.

4. The image processing device according to claim 1, wherein a tone of the letter region is decreased by applying the first color conversion table to color conversion.

5. The image processing device according to claim 1, wherein the background color density computing section computes the background color density by statistically processing a density distribution of the first image data.

6. The image processing device according to claim 1, wherein the image processing section has a letter region judging section which separates an image shown by the first image data into a letter region and a non-letter region, a color conversion table determining section which determines the first color conversion table to be applied to the letter region and determines the second color conversion table to be applied to the non-letter region, and a color converting section which removes the background color in the image by applying the first color conversion table to the letter region so as to convert the color of the letter region and applying the second color conversion table to the non-letter region so as to convert the color of the non-letter region.

7. A method for controlling an image processing device which generates first image data of a document by reading the document, generates second image data in which a background color of the document is removed by conducting a color conversion process to the first image data, and prints an image based on the second image data, comprising:
computing the background color density of the document from the first image data;
generating a first color conversion table and a second color conversion table based on the background color density; and
separating an image shown by the first image data into a letter region and a non-letter region, converts the color by applying the first color conversion table to the letter region, and converts the color by applying the second color conversion table to the non-letter region.

8. An image processing device, which generates first image data of a document by reading the document, generates second image data in which a background color of the document is removed by conducting a color conversion process to the first image data, and prints an image based on the second image data, comprising:
a background color density computing section which computes the background color density of the document from the first image data;
a color conversion table generating section which generates a first color conversion table and a second color conversion table based on the background color density; and
an image processing section which separates an image shown by the first image data into an edge region and a non-edge region, converts the color by applying the first color conversion table to the edge region, and converts the color by applying the second color conversion table to the non-edge region.
